(19) United States
(12) Patent Application Publication
(10) Pub. No.: US 2014/0372219 A1
(43) Pub. Date: Dec. 18, 2014

(54) SYSTEM AND METHOD FOR COMBINING ELECTRONIC SEARCHES WITH A PLATFORM FOR FULFILLING CONSUMER REQUESTS

(71) Applicant: Imagine If, Inc., Arlington, VA (US)

(72) Inventors: John K. Hart, Arlington, VA (US); Timothy C. Kosmider, Falls Church, VA (US)

(21) Appl. No.: 14/304,028

(22) Filed: Jun. 13, 2014

Related U.S. Application Data
(60) Provisional application No. 61/834,743, filed on Jun. 13, 2013.

(51) Int. Cl. G06Q 30/06

(52) U.S. Cl. CPC G06Q 30/0625
USPC 705/14.54; 705/26.62

(57) ABSTRACT

In some embodiments, a method of combining search and ecommerce includes receiving a search request from a consumer for a product and/or service. The method further includes executing the search request to yield one or more search results from a provider of the product and/or service. In some embodiments, the search results can include different response types from a provider to a consumer that can include an offer to fulfill the search request, a counter offer to the search request, or an executed purchase against the search request. The method also includes transmitting the one or more search results to the consumer.

### CROSS-REFERENCE TO RELATED APPLICATION

This application claims priority to U.S. Provisional Application No. 61/834,743 titled “SYSTEM AND METHOD FOR COMBINING ELECTRONIC SEARCHES WITH A PLATFORM FOR FULFILLING CONSUMER REQUESTS”, filed on Jun. 13, 2013, the disclosure of which is incorporated herein by reference in its entirety.

### BACKGROUND

Some embodiments described herein relate generally to methods and apparatus for executing electronic searches by combining search and electronic commerce.

From a consumer perspective, search tools present several challenges today: little guidance is provided as to the construct of smart searches, searches are frequently unilateral in that they do not involve direct interaction with vendors, and a large number of search results of varying relevance can be returned, which can often obscure truly relevant results.

Electronic commerce is an increasingly significant, consumer-driven component of the economy that also expects the consumer to be adept at searching for what the consumer desires. E-commerce provides some clear benefits to consumers (e.g. shopping from home), yet has significant drawbacks when it comes to enabling consumers to find what they need. For example, a significant amount of time is often involved to shop online because consumers still (virtually) visit each store. Most online businesses still organize the shopping experience by their goods and services rather than by starting from consumer need. To address this, a number of attempts have been made, with limited success, to produce consumer focused shopping portals. Such consumer focus, however is often diffused to groups of consumers, and fails to customize the shopping experience of the consumer at an individual level.

In some cases, behavioral tracking and data mining are used to build up extensive insights into each consumer, and can enable an online vendor to effectively and subsequently target a customer. Searches by consumers, however are frequently unilateral in that they do not involve direct interaction with vendors, which in turn prevents the vendor from effectively targeting the customer based on the customer's search.

A need exists, therefore, for methods and apparatus for combining search and electronic commerce to target a customer.

### BRIEF DESCRIPTION OF THE DRAWINGS

FIGS. 1A and 1B are schematic illustrations of an interface according to an embodiment.

FIG. 2 is a schematic illustration of an apparatus according to an embodiment.

FIG. 3 is a flow chart illustrating a method according to an embodiment.

FIG. 4 is a flow chart illustrating another method according to an embodiment.

FIG. 5 is a system for providing a consumer with one or more search results from one or more providers, according to an embodiment.

FIG. 6 is a schematic illustration of a portion of an apparatus according to an embodiment.

### DETAILED DESCRIPTION

In some embodiments, a method includes receiving a search request for a product and/or service from a consumer. The product and/or service can be any suitable entity of interest to the consumer such as, but not limited to, a product, a class of products, a particular brand of a product, a service, a service from a group or class of service providers, a service from a particular service provider, and/or the like (collectively hereafter “product”).

In some embodiments, the request can include one or more parameters associated with the product. The one or more parameters can be any aspect of the product that affects the customer's decision to use the product, and it is understood that the term ‘parameter’ can also be used to represent any suitable value(s) for the parameter assigned by the customer, and can encompass the scenario where the customer does not provide a value for the parameter. As an example, a date parameter for an airline flight search request can be a specific date, a range of dates, a specification of a weekend for a particular month, a specification for a month, unspecified, and/or the like.

In some embodiments, the one or more parameters can be specific to the product, and/or to a class of products. For example, if the search request is for a restaurant, the one or more parameters can include a desirable distance from the consumer's home/work/current location, a choice of cuisine(s), a price range, whether alcohol is served, restaurant noise level, distance from a sports venue to which the consumer has tickets, and/or the like. As another example, if the search request is for an airline flight, the one or more parameters can include a specification of an origin, a destination, a specific date and/or a date range, a specific time and/or a time range for departure/arrival, one or more preferred airlines, a price range and/or the like.

In some embodiments, the one or more parameters can be prioritized; in other words, aspects of the method permit the consumer to specify a relative importance of the parameters. In some embodiments, the priority can be specified by an ordered list of parameters. In some embodiments, the priority can be specified by a numerical representation associated with each of the one or more parameters. For example, a user who simply desires a budget ‘get-away’ vacation on a particular weekend can search for an airline flight and prioritize the origin, date, and price parameters, while assigning a lower priority to destination parameters, and/or provide no priority information for the destination parameters. In other embodiments, the priority is optional. In embodiments where no priority information is provided, any un-prioritized parameter(s) can be assigned a default priority, which can be the same for all un-prioritized parameters.

Each of the one or more parameters can be mandatory or optional. In some embodiments, at least one parameter can be deemed mandatory. In this manner, the consumer is required to provide at least some additional information about the product desired.

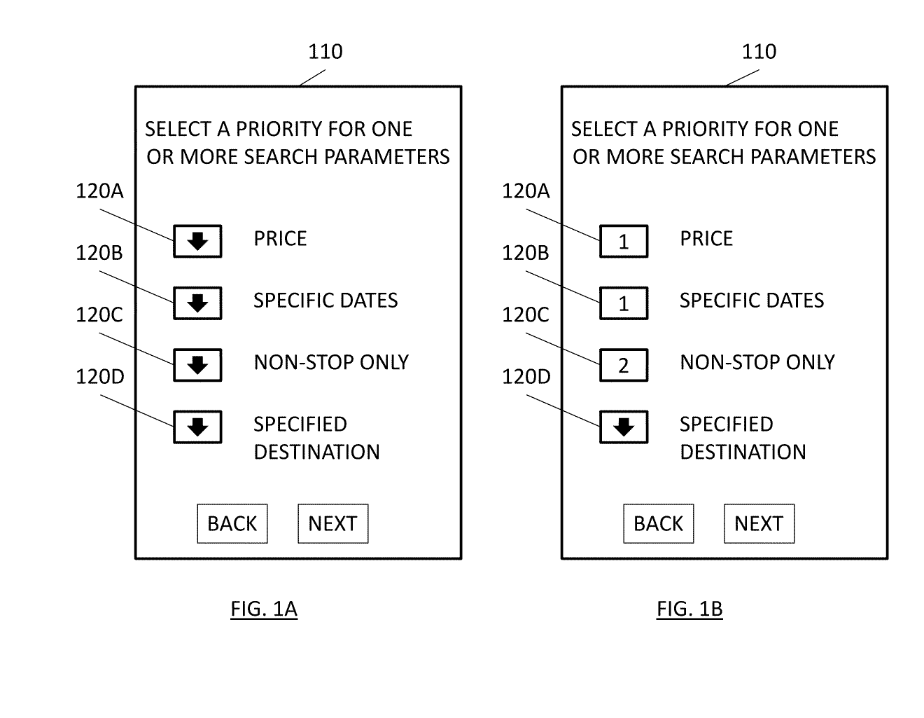

As a non-limiting example. FIGS. 1A-1B shows an interface 110 that can be provided to a consumer while building a search request for an airline ticket. For example, the interface 110 can be presented to a consumer as part of a consumer interface (explained in more detail later) and viewed by the consumer on a consumer device/application such as a web browser, a mobile application, and/or the like. FIG. 1A illustrates an interface asking the user to prioritize the search parameters associated with the consumer's search request, where drop-down elements 102A-102D can be manipulated to specify a priority for one or more of the ‘price’, ‘specific dates’, ;non-stop only’, and ‘specified destination’ search parameters associated therewith, respectively. As illustrated in FIG. 1B, the consumer can specify that price and exact dates are a top priority (both having a selected priority of ‘1’), while non-stop flights are of a lower priority (having a selected priority of ‘2’), and the destination is a non-issue for the consumer. By explicitly specifying that the destination is a non-issue, the consumer can effective communicate his intent not to be bound by the destination parameter, and thereby allow aspects of the invention to create more flexible search requests, i.e., with fewer constrains/greater degrees of freedom. In some embodiments, the destination is assigned the lowest priority possible, e.g., zero for this case. In other words, continuing with the example of a budget get-away vacation, the consumer can look for an airline ticket within his budget for a particular weekend without concern for the destination. In some embodiments (not shown), the consumer can be constrained to assign a unique priority to each search parameter the consumer elects to assign a non-default priority to.

In some embodiments, the search request (i.e., one or more of the search parameters) can further include a specification of a search duration. In other words, the consumer can specify a search start time (e.g., if the search is run immediately, or at a later time), a search start date, a search recurrence rate (e.g., if the search should be repeated, a recurrence rate for searching, etc.), a search end date (e.g. an end date for the search to stop executing and/or returning search results), and/or the like. Aspects of the method hence permit a customer to define instantaneous as well as ongoing searches. In some embodiments, the search request does not include a specification of a search duration, and the search is deemed to be instantaneous.

In some embodiments, the search request is for an ongoing search, and includes a notification specification for notifying the consumer of the search results, such as a summary thereof. The notification specification can include a mechanism of notification (e.g., text, email, via a cloud-based application, social media, and/or the like) and a frequency of notification (e.g., when search results are found, once every day, and/or the like). In some embodiments, the search request is associated with a consumer account (described later), and the consumer account in turn provides the notification specification. In this manner, the search results can be provided to the consumer based on the notification specification.

In some embodiments, the search request can further include an authorization specification to purchase the product, without any further input from the consumer, if the search yields one or more results. In this manner, consumers can ensure that a desirable product is not lost to another sale simply because the consumer was unavailable to authorize the purchase. For example, if a user wishes to buy a ‘get-away’ vacation on a particular weekend, he can authorize the purchase of an airline ticket that meets his origin, date, and price parameters. The authorization specification can include payment information (e.g. credit/debit/gift card information, online money accounts, and/or the like), a consumer account associated with payment information, and/or the like. In this manner, the search results can be provided to the consumer based on the authorization specification, and include an indication of a purchase of one or more search results based on the authorization specification.

In some embodiments, the search request can further include a specification and/or an authorization of whether the consumer permits counter-offers and/or promotions. In other words, the consumer can specify whether unmatched products may nevertheless be presented as search results.

In some embodiments, the search request can be received via a consumer interface provided to the consumer for constructing the search request. The consumer interface can be platform agnostic, i.e., it may not matter whether the consumer accesses the consumer interface via a desktop application, a mobile application, a cloud-based application, an online browser, and/or the like. In some embodiments, the consumer interface can provide a selectable listing of products, and further provide the one or more parameters specific for each listed product. In this manner, the consumer interface can provide a user-friendly format for allowing the consumer to ‘construct’ the search request while incorporating product constraints, parameter constraints, and so on. In some embodiments, the consumer interface can provide one or more selectable pre-existing offers, such as, for example, an advertisement for a product. The pre-existing offer can be made by any suitable entity, such as a provider of the product, an entity that provides the consumer interface to the consumer, and/or the like. In such embodiments, selecting the pre-existing offer by the consumer results in the automated construction of a search request based on the pre-existing offer, without any further input from the consumer.

As described above, aspects of the method are directed to receiving a search request for a product, including (in some embodiments) providing a consumer a consumer interface to build the received search request, in some embodiments, the method further includes executing the received search request for the product to determine search results. For example, executing the search request can include aggregating, combining, interlinking, and/or otherwise associating the search request with other search requests for the same product, such as in a database, for example. In other words, each database entry can correspond to a search request with entries for the one or more parameters of the search request. In some embodiments, additional information can be associated with the search request prior to aggregation including, but not limited to, consumer account information, geographic information, and/or the like. The consumer account information can include, but is not limited to, consumer identification information, payment information, reputation information, and/or the like. Reputation information can be any information associated with the search and/or purchasing history of the consumer and can include, but is not limited to, one or more average response rates associated with the percentage of offers, counter-offers, and/or promotions the consumers responded to prior to expiration, one or more average response times associated with the average time(s) taken by the consumer to respond to an offer, counter-offer, and/or promotion, and/or the like.

In some embodiments, at least a portion of the aggregated search requests and/or a portion of each search request is searchable by the provider of the product. In this manner, demand for a product can be reviewed, and responded to, at both the macroscopic as well as the single request level by the product provider. In some embodiments, the searchable portion does not include any customer identification information but can include reputation information, thereby ensuring customer privacy while permitting the provider to gather demand data. In some embodiments, the searchable portion is based on the provider information. For example, in some embodiments, the searchable portion does not include search requests for other products, i.e., those not offered by the product provider. As another example, in some embodiments, the searchable portion omits search requests originating from geographical areas to which the product provider does not ship. In this manner, access by the product provider to the aggregated search requests can be suitably restricted for reasons of privacy, effectiveness, by provider choice, and/or the like.

Accordingly, in some embodiments, executing the search request can include executing, once or periodically, a rule and/or a macroinstruction (“macro”) on the aggregated search requests, where the product provider can specify the rule/macro to define search request characteristics. For example, an airline provider can specify a rule/macro that returns search requests for a same-day flight of the airline provider that has a large number of available seats, and specify another rule/macro to simply determine demand for flights on Memorial Day weekend. In some embodiments, executing the search request can include notifying the product provider periodically, continually, and/or on demand of the results of the rule/macro execution.

In some embodiments, executing the search request can include receiving, in response to the notifying, one or more search results. In some embodiments, the one or more search results can be an offer, a counter-offer and/or a promotion to the consumer that may or may not meet the search request. In this manner, the product provider can make an offer that meets the consumer's request, a counter-offer that is closely related to the consumer's request and the consumer may be interested in (e.g., based on aggregated search request analysis of similar consumers, based on the consumer's interest in the product provider), and/or the like. It will be understood that unless explicitly stated otherwise, each ‘search result’ can independently include an offer, a counter-offers, or a promotion.

In some embodiments, the offer can be an otherwise unadvertised, unavailable offer, such as an unadvertised offer that is unavailable to all or a portion of other customers, for example. For example, a hotel provider can respond to a search request for a hotel room for immediate occupancy with an offer for a discount. In some embodiments, the offer can include an expiration date that specifies the duration of validity of the offer. In some embodiments, the expiration date can be based on the average response time of the consumer.

In some embodiments, the one or more search results can further include provider information associated with the provider(s) of the one or more search results. The provider information can include provider reputation information, which can be any information associated with the offer and/or offer redemption history of the provider and can include, but is not limited to, average offer acceptance rate (i.e., the percentage of offers made by the provider and accepted by the consumers prior to offer expiration), average counter-offer acceptance rate (i.e., the percentage of counter-offers made by the provider and accepted by the consumers prior to counter-offer expiration), average response time (i.e., the average time taken by the provider to respond to an instantaneous search request specifying the provider), and/or the like.

In some embodiments, the provider can pre-specify an offer to be made for search request(s) that meet specific characteristics (e.g., as can be determined by executing a provider-specified rule/macro) without any further input from the provider; in other words, the provider can pre-authorize offers to be provided as search results for matching search requests. In this manner, providers can ensure that a sale is not lost to another provider simply because an agent of the provider was unavailable to monitor the search requests and make the offer.

In some embodiments, the provider can view the aggregated search requests substantially in real time, and respond with one or more search results as described above, via a provider interface. In other words, while the user may or may not receive search results in real-time, the provider can remain informed of existing demand (i.e. based on unexpired search requests) on an ongoing basis. The interface can be platform agnostic as described earlier for the consumer interface.

In some embodiments, the method can further include transmitting the search results (to the consumer) in response to the received search request. In some embodiments, when the consumer has pre-authorized the purchase (as described earlier) and/or when a selection of one or more search results for purchase is received, the method can further include transmitting the purchase information to a payment processor for processing.

As used herein, a module can be, for example, any assembly and/or set of operatively-coupled electrical components, and can include, for example, a memory, a processor, electrical traces, optical connectors, software (executing in hardware), and/or the like. As used herein, the singular forms “a,” “an” and “the” include plural referents unless the context clearly dictates otherwise. Thus, for example, the term “a database” is intended to mean a single database or a set of databases with similar functionalities.

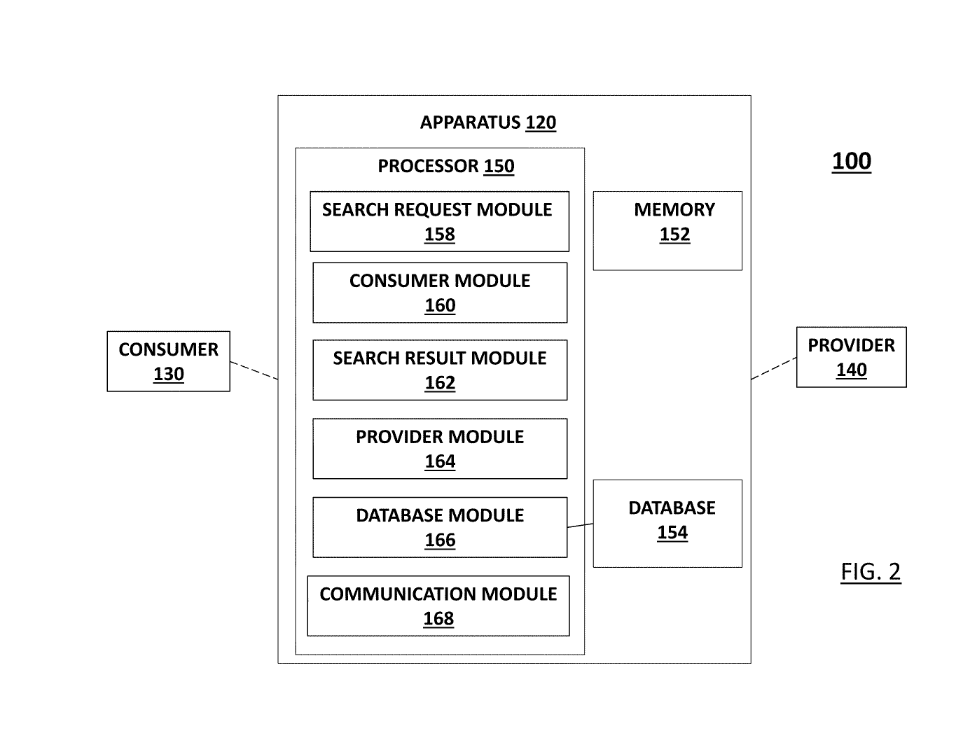

As shown in FIG. 2, an apparatus 120 that can be configured to combine search and electronic commerce, and is usable by a consumer 130 and a product provider 140. In other words, the apparatus 120 can be configured to implement aspects of the method described earlier, such as receiving one or more search requests from the consumer 130, executing the search requests to determine one or more search results in concert with the provider 140, and transmitting the one or more search results to the consumer 130. Hence, reference character 100 can represent an environment within which the apparatus 120 is configured to operate. It is noted that a single consumer and a single provider are illustrated here for simplicity; aspects are extendible and scalable to encompass multiple consumers and/or multiple providers. Each of the consumer 130 and the provider 140 can represent a personal computer, a server, a database, a work station, a mobile device, a cloud computing environment, an application or a module running on any of these platforms, and/or the like. Additionally, it is understood that each of the consumer 130 and the provider 140 can be any suitably representative human entity interacting with the apparatus 120, such as an actual person, an employee, and so on. Hence, it is understood that the consumer 130 and the provider 140 can be external to the system 100, as also illustrated by the use of dashed lines to designate the connectivity of the consumer and the provider to the apparatus 120.

The various components of the system 100 can be in communication (as indicated by lines in FIG. 2) via a network, which can be any type of network (e.g., a local area network or LAN, a wide area network or WAN, a virtual network, a telecommunications network, and/or the internet), implemented as a wired network and/or a wireless network. Any or all communications can be secured (e.g., encrypted) or unsecured, as is known in the art.

The apparatus 120 includes a processor 150 and a memory 152. The apparatus 120 also includes a database 154, although in some embodiments (not shown), the database can be external to the apparatus 120, and can optionally be external to the system 100 altogether. In some embodiments, the database 154 can be a third party entity with respect to the apparatus 120.

The processor 150 includes a search request module 158, a consumer module 160, a search result module 162, a provider module 164, a database module 166 to control operation of the database 154, and a communications module 168 to establish and manage network connectivity of the apparatus 150 with the consumer 130, with the provider 140, and within any type of network such as, but not limited to, a LAN, a WAN, a virtual network, a telecommunications network, the internet, and/or the like. The processor 150 can also include a control module (not shown) for manipulating aspects of the apparatus 120 and/or any of the other modules described here. It is to be understood that the each of the modules can be in seamless communication with each other module.

The search request module 158 is configurable to receive the search request from the consumer 130, and is further configurable to populate the database 154 (such as via the database module 166) and/or the memory 152 with the search request. In some embodiments, the search request module 158 is configurable to provide the consumer 130 with a consumer interface to generate the search request. In some embodiments, the search request module 158 is configurable to request and receive consumer account information associated with the search request from the consumer module 160, and to associate at least a portion of the consumer account information with the received search request prior to storage. In some embodiments, the search request module 158 is configurable to remove customer identification information from the consumer account information prior to association and/or storage. In some embodiments, the customer identification information can be removed by the search request module 158 consistent with one or more privacy regulatory standards or guidelines, including those established by Direct Marketing Association, Interactive Advertising Bureau, Digital Advertising Alliance, and Network Advertising Initiative. The search request module 158 is further configurable to transmit the search request to the search result module 162. The search request module 158 is further configurable to receive search results from the search result module 162 and to transmit the search results to the consumer 130 and/or to a payment processor (not shown), in embodiments where the consumer has preauthorized a purchase (described earlier). In some embodiments, the search request module 158 is further configurable to update the consumer reputation information in the database 154 (either via the database module 166 and/or via the consumer module 160) to reflect the consumer's purchase, or lack thereof.

The consumer module 160 is configurable to receive, modify, update, and/or otherwise maintain consumer information such as consumer account information, geographic information, and/or the like. The consumer module 160 can be configured to store the consumer information in the database 154 (such as via the database module 166) and/or the memory 152. The consumer account information can include, but is not limited to, consumer identification information, payment information, reputation information, and/or the like. Reputation information can be any information associated with the search and/or purchasing history of the consumer and can include, but is not limited to, average response rate (i.e., the percentage of offers the consumers responded to prior to offer expiration), average response time (i.e., the average time taken by the consumer to respond to an offer), and/or the like. In some embodiments, the consumer module 160 is configurable to remove customer identification information from the consumer account information prior to transmission to entities other than the consumer 130, such as to the search request module 158.

The search result module 162 is configurable to receive the search request from the search request module 158, and to execute the search request. In some embodiments, the search result module 162 is configurable to transmit the search request to the provider 140 and to receive one or more search results in response. In some embodiments, the search result module 162 is configurable to transmit the search request to the provider 140 only if the provider meets one or more search criterion, e.g., if the search request specifies the provider 140, or a group of providers including the provider 140, or the provider 140 is found in a specified zip code, and/or the like. In some embodiments, the search result module 162 is configurable to provide the provider 140 with a provider interface for viewing the search request and for providing one or more search results in response thereto.

In some embodiments, the search result module 162 is configurable to transmit the search request to the provider module 164 and to receive, in response, one or more search results, though in other embodiments, no search results may be provided and/or otherwise available. For example, a provider may choose not to respond to a search request visible to the provider, or may choose to communicate to the user that no search results are being provided. In some instances, the one or more search results include at least one offer that matches the search request. For example, in some embodiments, the offer specifies a particular provider, and the search result is provided by the provider. In some instances, the one or more search results can include at least one counter-offer that is related to, but may not match, the search request. In some instances, the counter-offer can meet some but not all the search parameters specified by the consumer. For example, in some embodiments, the offer specifies a particular provider (e.g., the provider 140), and the counter-offer is made by the provider, or by an entity other than the specified provider. In some instances, the entity other than the specified provider can be associated with the apparatus 120, while in other instances, the entity is a third party with respect to the apparatus 120 and with respect to the specified provider. The third party and/or the entity can be associated with the apparatus 120 may or may not have a related agreement with the particular provider to make the counter-offer. Non-limiting examples of such third parties can include, but are not limited to, wholesalers, retailers, agents such as travel agents, and/or the like.

The one or more search results can include at least one promotion that can be related or unrelated to the search request. When no search results are found and the search request specifies a persistent search, the search result module 162 is configurable to reexecute the search request periodically. Advantageously, due to the ongoing dynamics (e.g., constantly changing prices, availability, etc.) within a marketplace, periodic reexecution of the search request increase the possibility of a user's request being fulfilled over time by changes in the marketplace (e.g. lowering of price, ticket cancellation by others, newly available pre-authorized search results by providers, etc.).

The search result module 162 is further configurable to transmit any search results to the search request module 158. The search result module 162 is further configurable to transmit any search results to the provider 140. In some embodiments, the one or more search results can have provider information associated therewith, including provider reputation information.

The provider module 164 is configurable to receive, modify, update, and/or otherwise maintain provider information such as provider account information (including provider reputation information), rules/macros run or specified by the provider, pre-authorized search results, and/or the like. In some instances, the provider module 164 is configurable to receive the search request from the search result module 162 and to determine one or more pre-authorized search results based on the provider information. The provider module 164 is configurable to receive the search request from the search result module 162 and to execute one or more rule/macro on the database 154 (via the database module 166). The provider module 164 is further configurable to receive from the database module 166, in response to executing the rules/macros, one or more search results, which can then be transmitted to the search result module 162 and/or the provider 140.

The consumer 130 can receive the search results via the search request module 158 in any suitable manner, such as, for example, a result marked as a new, unopened email message, a text message on a mobile device, a link to an online listing of the search result, and/or the like. The consumer 130 can manipulate the search result(s) to accept the offering in the search result, to expressly reject the offering in the search result, or take no action. For example, the consumer 130 may never open the email message with the search result, or never click on the link with the search result. As another example, the consumer 130 may view the search result, but choose not to respond. As yet another example, the consumer 130 may delete the search result, with or without viewing it.

The processor 150 can be any suitable processor configured to run and/or execute the module(s) included in the processor 122. Each module in the processor 150 can be any combination of hardware-based module (e.g., a field-programmable gate array (FPGA), an application specific integrated circuit (ASIC), a digital signal processor (DSP)) and/or software-based module (e.g., a module of computer code stored in the memory 152 and/or executed at the processor 150) capable of performing one or more specific functions associated with that module. In some embodiments, the processor 150 can include other module(s) (not shown in FIG. 1) configured to perform other function(s) for the apparatus 120. For example, the processor 150 can include a visualization module configured to generate different views of the aggregated search requests in the database 154.

In some embodiments, the memory 152 can be, for example, a random-access memory (RAM) (e.g., a dynamic RAM, a static RAM), a flash memory, a removable memory, and/or so forth. In some embodiments, the memory 152 encompasses the database 154. Additionally, although not shown in FIG. 1, other data or information can be stored in other portions of the memory 152.

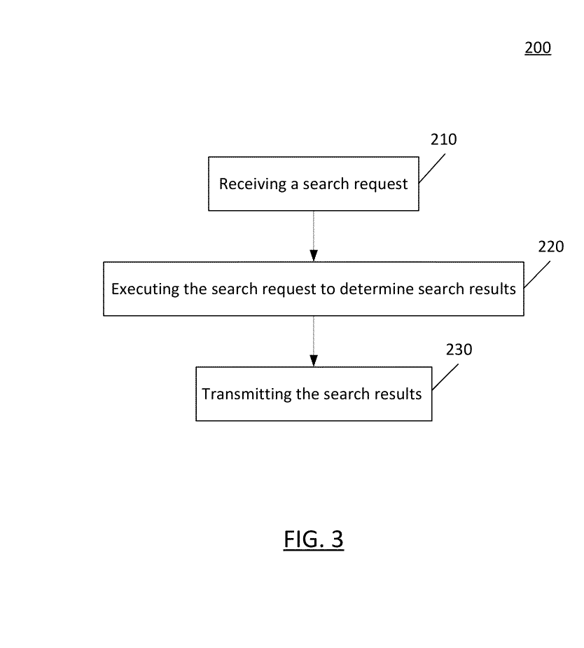

FIG. 3 is a flow chart illustrating a method, according to an embodiment, for executing a search request by combining search and electronic commerce, thereby providing a consumer (e.g. the consumer 130) with one or more search results from one or more providers (e.g. the provider 140) in response to the search request from the consumer. The method 200 can be performed by the apparatus 120, or any apparatus structurally/functionally similar to the apparatus 120. Instructions associated with performing the method 200 can be stored, for example, in a memory of the apparatus (e.g., the memory 152 of the apparatus 120 in FIG. 2) and executed by one or more modules in a processor of the apparatus (e.g., the various modules in the processor 150 of the apparatus 120 in FIG. 2).

At 210, a search request module can be configured to receive a search request for a particular product. The search request module can be further configured to aggregate the received search request with other search requests for the particular product in a database. The search request module can be further configured to associate consumer information with the received search request, and optionally to remove consumer identification information from the received search request. The search request module can be further configured to provide a consumer interface to a consumer, and to receive the search request via the consumer interface. The search request module can be further configured to transmit the received search request to a search result module.

At 220, the search result module can be configured to execute the search request to determine one or more search results associated with the search request. The search result module can be further configured to transmit the received search request to a provider and/or a provider module. The search result module can be further configured to provide the provider with a provider interface for viewing the search request and for providing one or more search results in response thereto. The search result module can be further configured to receive one or more search results from the provider module and/or the provider. The search result module can be further configured to transmit the received one or more search results to the search request module 158.

At 230, the search request module can be configured to transmit the one or more search results received from the search result module to the consumer in response to the search request. In some embodiments, the search request module can be configured to transmit at least one search result to a payment processor for execution.

Product-specific smart questions can be leveraged to quickly help the consumer identify and prioritize the relevant parameters of the search and purchase experience. While enabling traditional search and purchase behavior, albeit through significantly enhanced search functionality, the consumer can be provided with the ability to produce multiple, persistent, smart search requests. The persistent search requests can provide notification of new search results, such as resulting from dynamic availability and/or dynamic pricing by providers. The consumer can authorize the purchase of any matches in advance.

By separating the moment of search from the moment of purchase, and encouraging the construction of multiple requests by the same consumer, consumer demand can be determined more effectively by a provider through the aggregation of search requests from the same consumer, across multiple consumers, across multiple products, and/or the like. A provider can examine these aggregated consumer requests via a provider interface of the invention. Providers have the ability to easily locate geographically relevant demand associated with relevant consumer characteristics, such as the consumer reputation.

Hence, consumer demand/request can be matched with provider supply at the individual consumer level. Providers have the ability to execute on consumer requests by issuing pre-authorizations, and also have the ability to make individual offers for each search request, as well as to provide counter-offers that include non-monetary incentives such as loyalty rewards, etc. In this manner, the aggregated search requests provide a common set of data against which each provider can apply its own dynamic and contextual business knowledge.

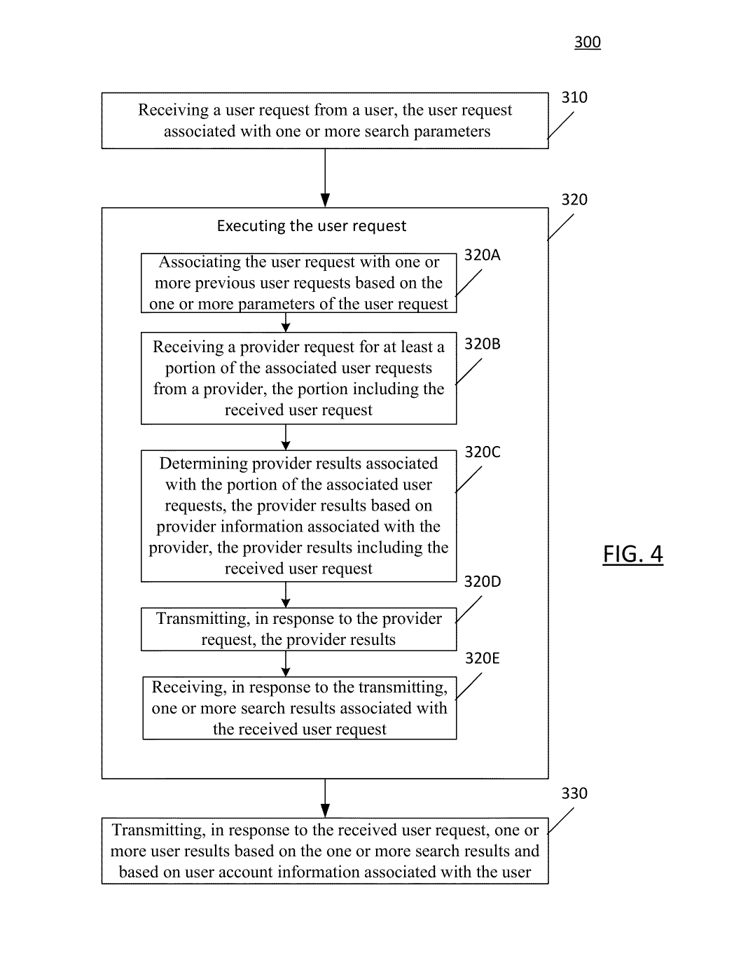

FIG. 4 is a flow chart illustrating a method 300, according to an embodiment, for providing one or more search results from one or more providers (e.g. the provider 140) in response to a search request from the consumer. The method 300 can be performed by the apparatus 120, or any apparatus structurally/functionally similar to the apparatus 120. Instructions associated with performing the method 300 can be stored, for example, in a memory of the apparatus (e.g., the memory 152 of the apparatus 120 in FIG. 2) and executed by one or more modules in a processor of the apparatus (e.g., the various modules in the processor 150 of the apparatus 120 in FIG. 2).

At 310, the method 300 includes receiving a user request from a user. The user request is associated with one or more search parameters.

At 320, the method 300 includes executing the user request. In some embodiments, executing the user request includes performing steps 320A-320E, as discussed in more detail herein. At 320A, the user request is associated with one or more previous user requests based on the one or more parameters of the user request. In some embodiments, the method 300 further includes, prior to associating the user request with previous user requests at 320A, associating the user request with at least one of consumer account information of the user of the user request and geographic information.

At 320B, a provider request is received for at least a portion of the associated user requests from a provider (e.g. the provider 140), the portion including the received user request. In some embodiments, receiving the provider request at step 320B includes periodically executing a rule specified by the provider. In some embodiments, the method 300 further includes determining the portion of the associated user requests based on the provider information.

At 320C, provider results are determined that are associated with the portion of the associated user requests. The provider results are based on provider information associated with the provider. In this embodiment, the provider results include the received user request.

At 320D, the provider results are transmitted in response to the provider request, such as to the provider 140, for example. At 320E, in response to the transmitting, one or more search results associated with the received user request are received (e.g., from the provider 140). In some embodiments, the method 300 further includes removing, prior to transmitting the provider results in step 320E, consumer identification information from the provider results. In some embodiments, receiving the provider request at step 320B includes receiving a provider request including periodically executing a rule specified by the provider, and transmitting the provider results at step 320D further includes notifying the provider periodically, continually, or on demand, of the provider results obtained from executing the rule.

In some embodiments, executing the user request at step 320 can further include associating provider information with the provider results to generate the one or more search results.

At 330, the method 300 further includes transmitting, in response to the received user request, one or more user results based on the one or more search results and based on user account information associated with the user.

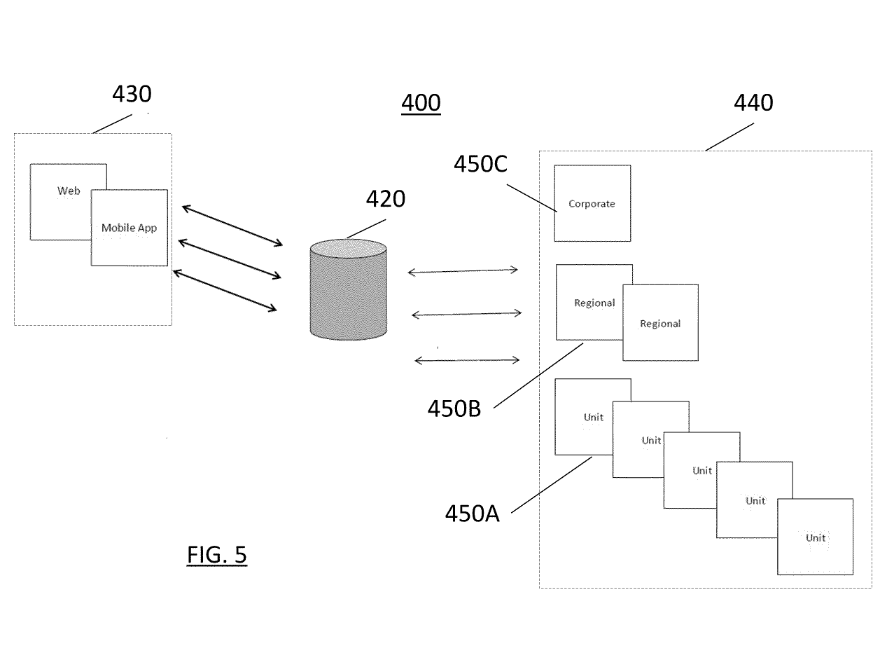

FIG. 5 illustrates a non-limiting example of a system 400 (e.g., similar to the system 100 of FIG. 1) for providing a consumer (e.g. the consumer 130) with one or more search results from one or more providers (e.g. the provider 140) in response to the search request from the consumer. As illustrated in FIG. 5, a consumer device 430 such as a smart phone can access an apparatus 420 (similar to apparatus 120) via a web browser and/or a cloud-based application (‘mobile app’) to specify one or more search requests with multiple dimensions/parameters. The apparatus 420 in turn communicates with a provider 440 (similar to the provider 140) to determine search results (if any) as described earlier. The consumer 430 can review and purchase one or more of the search results, or if the search requests includes pre-authorization, the apparatus 420 can review and purchase one or more of the search results if the pre-authorization criteria are met. If no search results are returned and the search request specifies a persistent search (e.g., for 5 days for example), the apparatus 420 can run the search dynamically until a search result is found due to dynamic availability and/or pricing from the provider 440. The consumer 430 can be notified (via the mobile app, for example) when a search result is found and optionally automatically purchased on behalf of the consumer. As noted earlier, the search results can include offers and/or counter-offers, and can each be associated with an expiration date.

In some embodiments and as also illustrated in FIG. 5, the aggregated search requests can be made differentially accessible to different organizational levels 450A-450C for the same provider 440, such as based on geography and/or corporate hierarchy. For example, each unit of the provider 440 (where all units of the provider are collectively represented by the reference character 450A) in FIG. 5 can be associated with a geographically distributed franchise of the provider 440, where each unit can only access search requests originating within its associated geographical area. Similarly, each regional office of the provider 440 (where all regional offices of the provider are collectively represented by the reference character 450B) can be associated with a regional monitoring office for several of the units 450A, thereby enabling the regional office to monitor the search requests/demand across multiple geographical areas and/or for each unit. Further, a corporate office 450C of the provider 440 can monitor search requests/demand across the entire breadth of the provider's offerings and/or locations.

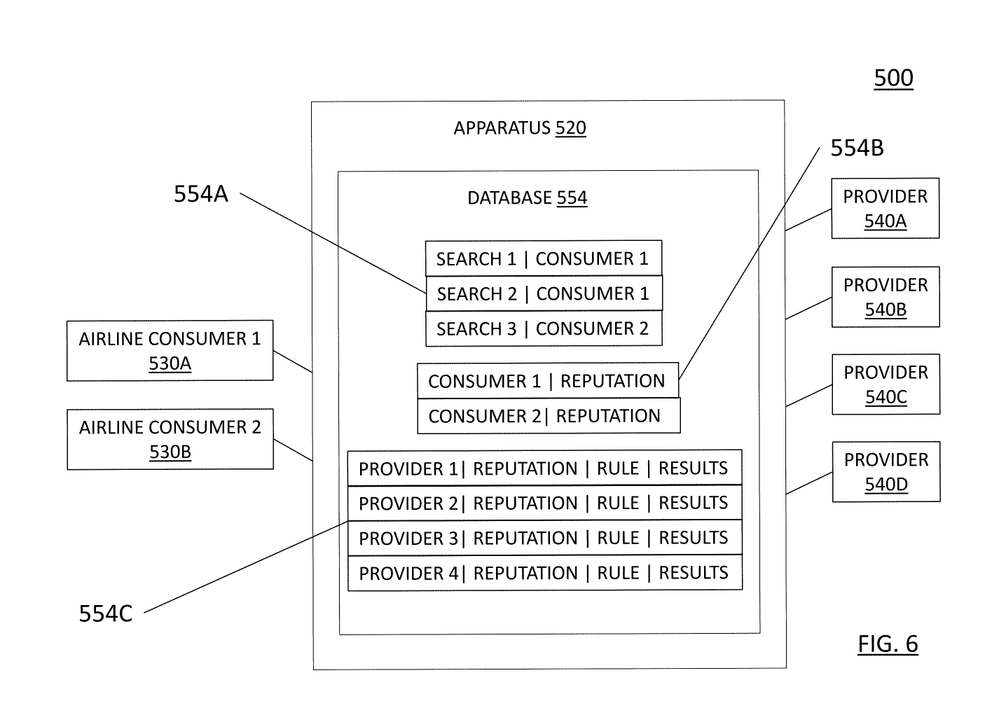

FIG. 6 illustrates a non-limiting example of operation of a system 500 (similar to the system 100) for providing a consumer (e.g. the consumer 130) with one or more search results from one or more providers (e.g. the provider 140) in response to the search request from the consumer. In this example, an airline consumer 530A wishes to purchase two airline tickets: the first ticket is for the very next day to visit a suddenly ailing relative, and the second ticket for the 4^{th} of July weekend (e.g., which can be a couple of months away) to travel to any destination. The consumer 530A can construct a first search (“Search 1”) for the first ticket as an instantaneous search that can specify (such as via a consumer interface that includes the interface of FIG. 1) high priority for a particular destination, date, and non-stop flights. In other words, the consumer 530A could employ the interface of FIG. 1 to specify a priority of ‘1’ for 120B-120D, and leave 120A as unspecified, or set 120A to a priority of 2 or lower. The consumer 530A can also construct a second search (“Search 2”) for the second ticket as a persistent search to last for a month, and that can specify a high priority for 120B (specific dates), say ‘1’, a lower priority for 120A (price), say ‘2’, and leave 120C-120D as unspecified, or set 120C-120D to a priority of 3 or lower.

The apparatus 520 (similar to the apparatus 120, shown here only with the database 554 for simplicity) is configurable to store the Search 1 and Search 2 in the search database/table 554A of the database 554, which also includes searches by other users, such as Search 3 by the airline consumer 530B. As also illustrated in FIG. 6, the apparatus 520 can combine the search with consumer information (e.g., consumer reputation information), such as can be gleaned from a consumer information database/table 554B of the database 554. A set of airline providers 540A-540D can be made aware of Search 1 and Search 2, either directly and/or by execution of rules associated with the airline providers 540A-540D on the search database 554A, where the rules can be determined by looking up the provider information in a provider database 554C. The provider 540A-540D can then respond accordingly with search results. For example, the provider 540B can be a travel agent with surplus tickets for the next day flight, and be able to instantaneously offer a discounted ticket offer in response to Search 1. As another example, the provider 540D can be an airline with which the consumer 530A has reward points associated therewith (and which can be gleaned from the consumer information in the consumer database 554B), and can offer the customer a free upgrade in response to Search 1 and/or Search 2.

Additionally, one or more pre-authorized search results associated with the provider information can be returned as a search result for Search 1 and/or Search 2. For example, a pre-authorized search result by provider 540A (stored in the provider database 554C) might be a 4^{th} of July promotional sale, which can be provided in response to Search 2. The apparatus 520 can then combine the search results with the provider information, such as provider reputation information from the provider database 554C, and transmit the search results to the consumer 530A, via a medium or mechanism as can be specified in the consumer database 554B (text, email, etc.). Because no pre-authorization was provided in this case, the apparatus 520 determines if the consumer 530A purchases any of the search results for Search 1 and/or Search 2, and updates the consumer reputation in the consumer database 554B accordingly.

The apparatus 520 can also periodically re-run the Search 2 request, if the consumer 530A does not purchase any of the Search 2 results, or if no results are found for Search 2. For example, if provider 530C releases a fresh batch of tickets for 4^{th} of July at a later date (but prior to expiration of Search 2) that meet the Search 2 criteria, the consumer 530A can be notified of the availability of new search results from provider 530C.

It is intended that the systems and methods described herein can be performed by software (stored in memory and/or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to devices (e.g., wireless access points, mobile communication devices) with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

What is claimed is:

1. A method, comprising:
receiving a specification of a consumer interface for building a user request;
displaying, on a user device of a user, a user interface based on the received specification;
receiving, in response to said displaying, a plurality of parameters, the plurality of parameters including one or more search parameters, at least one search parameter having a priority value associated therewith;
building, based on the received plurality of parameters, one or more user requests;
transmitting the one or more user requests for execution; and
receiving, based on the one or more user requests, one or more user results.

2. The method of claim 1, the one or more search parameters including one or more of the following: a search start time, a search start date, a search recurrence rate, a search end date.

3. The method of claim 1, wherein building the user request further comprises associating, for each search parameter not having a priority value associated therewith, a default priority value.

4. The method of claim 1, wherein each search parameter has a unique priority value associated therewith.

5. The method of claim 1, wherein:
the one or more search parameters includes a notification specification,
the receiving the one or more user results includes receiving a notification of the user results based on the notification specification.

6. The method of claim 1, wherein:
the one or more search parameters including an authorization specification, wherein the receiving the one or more user results includes receiving an indication of a purchase associated with one or more of the user results based on the authorization specification.

7. The method of claim 1, wherein:
the one or more search parameters includes an authorization to receive one or more of counter-offers and promotions,
the receiving the one or more search results includes receiving one or more counter-offers or promotions, or both, based on the authorization.

8. A method, comprising:
receiving a user request from a user, the user request associated with one or more search parameters;
executing the user request, including:
associating the user request with one or more previous user requests based on the one or more parameters of the user request;
receiving a provider request for at least a portion of the associated user requests from a provider, the portion including the received user request;
determining provider results associated with the portion of the associated user requests, the provider results based on provider information associated with the provider, the provider results including the received user request;
transmitting, in response to the provider request, the provider results; and
receiving, in response to the transmitting, one or more search results associated with the received user request; and
transmitting, in response to the received user request, one or more user results based on the one or more search results and based on user account information associated with the user.

9. The method of claim 8, further comprising, prior to associating the user request with previous user requests, associating the user request with at least one of consumer account information of the user of the user request and geographic information.

10. The method of claim 8, further comprising removing, prior to transmitting the provider results, consumer identification information from the provider results.

11. The method of claim 8, further comprising determining the portion of the associated user requests based on the provider information.

12. The method of claim 8, receiving a provider request including periodically executing a rule specified by the provider.

13. The method of claim 8, receiving a provider request including periodically executing a rule specified by the provider, and transmitting the provider results including notifying the provider periodically, continually, or on demand, of the provider results obtained from executing the rule.

14. The method of claim 8, executing the user request further comprising associating provider information with the provider results to generate the one or more search results.

15. An apparatus, comprising:
a database configured to store user requests from one or more users, provider information for one or more providers, and user account information for the one or more users;
a processor executing instructions for:
a search request module for receiving a user request from a user of the one or more users, the user request associated with one or more search parameters; and
a search result module configured for executing the user request, including:
associating the received user request with one or more user requests stored in the database, the associating based on the one or more parameters of the received user request;
receiving a provider request for at least a portion of the associated user requests from a provider of the one or more providers, the portion including the received user request;
determining provider results associated with the portion of the associated user requests, the provider results based on provider information stored in the database and associated with the provider, the provider results including the received user request;
transmitting, in response to the provider request, the provider results; and
receiving, in response to the transmitting, one or more search results associated with the received user request,
the search request module transmitting, in response to the received user request, one or more user results based on the one or more search results and based on user account information stored in the database and associated with the user.

16. The apparatus of claim 15, the search result module further configured for removing, prior to transmitting the provider results, consumer identification information from the provider results.

17. The apparatus of claim 15, the search result module further configured for determining the portion of the associated user requests based on the provider information.

18. The apparatus of claim 15, wherein the provider information includes product offerings by the provider, and wherein the portion of the associated user requests includes requests for the product offerings.

19. The apparatus of claim 15, wherein the provider information includes geographical criterion, and wherein the portion of the associated user requests includes user requests meeting the geographical criterion.

20. The apparatus of claim 15, receiving a provider request including periodically executing a rule specified by the provider, and transmitting the provider results including notifying the provider periodically, continually, or on demand, of the provider results obtained from executing the rule.

21. The apparatus of claim 15, the search result module further configured for associating provider information with the provider results to generate the one or more search results.
